(19) United States
(12) Patent Application Publication
(10) Pub. No.: US 2009/0236332 A1
(43) Pub. Date: Sep. 24, 2009

(54) Microwave oven turntable apparatus

(76) Inventor: Steven L. Adams, Cedar Park, TX (US)

Correspondence Address: Steven L. Adams, 3101 Welton Cliff, Cedar Park, TX, 78613, US

(21) Appl. No.: 12/077,336

(22) Filed: Mar. 18, 2008

(51) Int. Cl. H05B 6/66

(52) U.S. Cl. 219/702; 219/754

(57) ABSTRACT

A turntable apparatus is provided for use in a microwave oven which includes a turntable driving motor, turntable drive mechanism connected to the turntable driving motor, an oven door, and a door switch. The subject apparatus is comprised of a turntable unit which is mechanically connected to the turntable drive gearing. The turntable unit includes a plurality of article sensors which suitably may be weight sensors, photo-sensors, or the like. A turntable control microprocessor is electrically connected to the turntable driving motor, to the plurality of sensors, and to the door switch. By receiving signals from the sensors and from the door switch, and by sending signals to the turntable driving motor to rotate the turntable unit, the turntable control microprocessor is adapted to automatically adjusts the position of the turntable unit (and a sensed food container placed thereon) with respect to the oven door such that the food container is proximal to the oven door when the oven door is open.

### BACKGROUND OF THE INVENTION

1. Field of the Invention

The present invention relates generally to microwave ovens, and, more particularly, to microwave ovens having sensors for the microwave turntable and a drive for the turntable responsive to the sensors and controlled by a microprocessor to automatically index the turntable when the microwave door is open.

2. Description of the Prior Art

Microwave ovens having turntables are well known in the art. Throughout the years, a number of innovations have been developed relating to microwave ovens having turntables, and the following U.S. patents are representative of some of those innovations: U.S. Pat. Nos. 4,424,431, 5,345,068, 5,463,207, 6,696,678, and 6,956,191.

Both U.S. Pat. No. 4,424,431 and U.S. Pat. No. 5,345,068 disclose a respective microwave oven having a turntable which slides outside of the cooking chamber for loading and unloading of the turntable.

U.S. Pat. No. 5,463,207 discloses a microwave oven having a turntable beneath which a weight sensor senses the weight of the food that is being cooked which serves as a indicator of the completeness of cooking. The weight sensor is not used for positioning the turntable with respect to the oven door.

U.S. Pat. Nos. 6,696,678 and 6,956,191 may be of interest for their disclosure of additional microwave ovens having turntables.

One common problem often associated with the use of a microwave oven is the location of the food on the turntable with respect to the oven door after the microwave heating has been completed. For example, when a cup of coffee is placed on the turntable in a position that is displaced from the center of the turntable, when the heating process is complete, the coffee cup may be located on the turntable in a position that is not near the oven door. As a result, the user must reach far inside the microwave oven to retrieve the heated cup of coffee. In the process of reaching far inside the microwave oven, the heated product is susceptible to being knocked over or spilled.

As stated above, both U.S. Pat. No. 4,424,431 and U.S. Pat. No. 5,345,068 disclose a respective microwave oven having a turntable which slides outside of the cooking chamber for loading and unloading of the turntable. When a turntable is slid out from the oven chamber, the food item on the turntable can be easily accessed. However, such turntables that slide inside and outside of an oven chamber require complex turntable support structures.

In view of the above, it is clear that none of the patents discussed above discloses a microwave oven having a turntable in which the turntable is completely retained inside the microwave oven and in which a plurality of sensors are used to suitably control rotation of the turntable so that the food in the microwave oven is positioned at the front of the microwave oven where the oven door is opened.

Still other features would be desirable in an article sensing microwave oven turntable apparatus. With a plurality of sensors and with a motor for rotating the turntable, it would be desirable if a microwave oven turntable apparatus included a microprocessor for controlling the turntable rotation motor to properly position the turntable at the microwave door.

For a plurality of article sensors associated with a turntable, it would be desirable if the turntable were divided into a plurality of sectors, and it would be desirable if each sector had an associated sensor.

Since an important feature of the present invention is to position an object which is present on the turntable at the microwave door when the microwave heating is complete, and since whether the door is closed or open is monitored by a door switch, it would be desirable if control of a turntable motor were dependent upon the status of a microwave door switch and the presence of an article on a particular portion of the microwave turntable.

Thus, while the foregoing body of prior art indicates it to be well known to use a microwave turntable that has a weight sensor, for example, the prior art described above does not teach or suggest a microwave oven turntable apparatus which has the following combination of desirable features: (1) the turntable is completely retained inside the microwave oven; (2) a plurality of sensors are used to control rotation of the turntable so that the food in the microwave oven is positioned at the front of the microwave oven where the oven door is opened; (3) includes a microprocessor responsive to the sensors for controlling the turntable rotation motor to properly position the turntable at the microwave door; (4) the turntable is divided into a plurality of sectors, and each sector has an associated article sensor; and (5) control of a turntable motor is dependent upon the status of a microwave door switch.

The foregoing desired characteristics are provided by the novel article sensing microwave oven turntable apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides an article sensing turntable apparatus for use in a microwave oven which includes a turntable driving motor, turntable drive mechanism such as suitable gearing connected to the turntable driving motor, an oven door, and a door switch. The subject apparatus is comprised of a turntable unit which is mechanically connected to the turntable drive mechanism (gearing). The turntable unit includes a top turntable platform portion, a plurality of article sensors located under the top turntable platform portion and preferably, which support the top turntable platform portion, and a turntable base which supports the plurality of sensors. Turntable control means are electrically connected to the turntable driving motor, are electrically connected to the plurality of weight sensors, and are electrically connected to the door switch. The turntable control means control the position of the turntable unit with respect to the oven door when the oven door is open, by receiving signals from the article sensors and from the door switch, and by sending signals to the turntable driving motor. The turntable control means cause the turntable unit to rotate so that an item on the turntable unit is positioned proximally with respect to the oven door when the oven door is open.

Preferably, the plurality of article sensors are in the form of weight sensors arrayed around the turntable unit in a circular pattern. In addition, each of the plurality of weight sensors is associated with a pie-shaped sector of the turntable unit. More preferably, eight weight sensors are associated with eight pie-shaped sectors that are arrayed radially around a turntable center.

Preferably, the turntable control means include a programmable microprocessor, and a power supply is electrically connected to the microprocessor. The plurality of weight sensors and the door switch provide input signals to the microprocessor, and the turntable driving motor is controlled by output signals from the microprocessor.

The microprocessor is programmed to sense which weight sensor is sensing the greatest amount of weight on the top turntable platform portion, to sense when the oven door is open as signalled by the door switch, to activate the turntable driving motor to drive the turntable drive mechanism or gearing to rotate the turntable unit such that the weight sensor which is sensing the greatest amount of weight on the top turntable platform portion and its associated top turntable portion are moved to a position proximal to the oven door when the microwave door-switch is activated.

In accordance with another aspect of the invention, a method is provided for controlling the position of a turntable unit with respect to a microwave oven door, wherein the turntable unit is driven by a turntable driving motor. The subject method comprises the steps of:

providing a plurality of article sensors in the turntable unit,

providing a door switch for the oven door, and

providing a programmable microprocessor for sensing which sensor is sensing the presence of an article on the turntable unit, for sensing when the oven door is open as signalled by the door switch, and for activating the turntable driving motor to drive the turntable unit such that said sensor which is sensing the article on the top turntable platform portion and its associated top turntable portion are moved to a position proximal to the oven door when the door is open.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved weight sensing microwave oven turntable apparatus which has all of the advantages of the prior art and none of the disadvantages.

It is another object of the present invention to provide a new and improved weight sensing microwave oven turntable apparatus which may be easily and efficiently manufactured and marketed.

It is a further object of the present invention to provide a new and improved weight sensing microwave oven turntable apparatus which is of durable and reliable construction.

An even further object of the present invention is to provide a new and improved weight sensing microwave oven turntable apparatus which is susceptible of a low cost of manufacture with regard to both materials and labor, and which accordingly is then susceptible of low prices of sale to the consuming public, thereby making such weight sensing microwave oven turntable apparatus available to the buying public.

Still yet a further object of the present invention is to provide a new and improved microwave oven turntable apparatus in which the turntable is completely retained inside the microwave oven.

Still another object of the present invention is to provide a new and improved microwave oven turntable apparatus that includes a plurality of article sensors that are used to control rotation of the turntable so that the food in the microwave oven is positioned at the front of the microwave oven where the oven door is opened.

Yet another object of the present invention is to provide a new and improved article sensing microwave oven turntable apparatus which includes a microprocessor for controlling the turntable rotation motor to proximally position the turntable at the microwave door when the door is open.

Even another object of the present invention is to provide a new and improved weight sensing microwave oven turntable apparatus in which the turntable is divided into a plurality of sectors, and in which each sector has an associated weight sensor.

Still a further object of the present invention is to provide a new and improved weight sensing microwave oven turntable apparatus in which control of a turntable motor is dependent upon the status of a microwave door switch.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a front view showing a preferred embodiment of the weight sensing microwave oven turntable apparatus of the invention.

FIG. 2 is an enlarged top view of the turntable that is inside the microwave oven, wherein the view is taken along line 2-2 of FIG. 1.

FIG. 3 is an enlarged edge view of the embodiment of the weight sensing microwave oven turntable apparatus of FIG. 2 taken along line 3-3 thereof.

FIG. 4 is a cross-sectional view of the embodiment of the invention shown in FIG. 3, taken alone line 4-4 thereof.

FIG. 5 is a cross-sectional view of the embodiment of the invention shown in FIG. 1, taken along line 5-5 of FIG. 1.

FIG. 6 is an electrical block diagram of the control circuitry for the embodiment of the invention shown in FIGS. 1-5.

### DESCRIPTION OF THE PREFERRED EMBODIMENT

With reference to the drawings, a new and improved weight sensing microwave oven turntable apparatus embodying the principles and concepts of the present invention will be described.

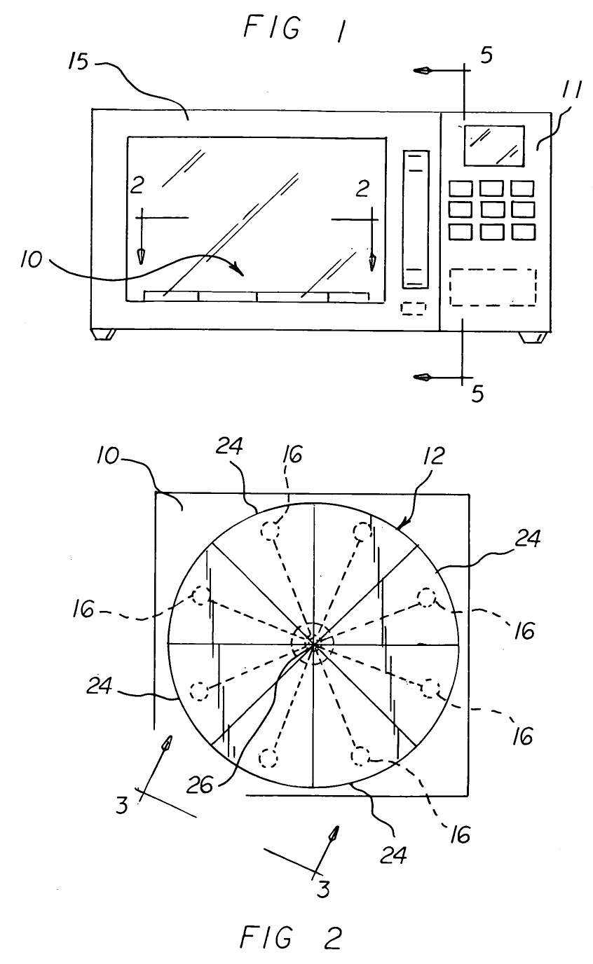

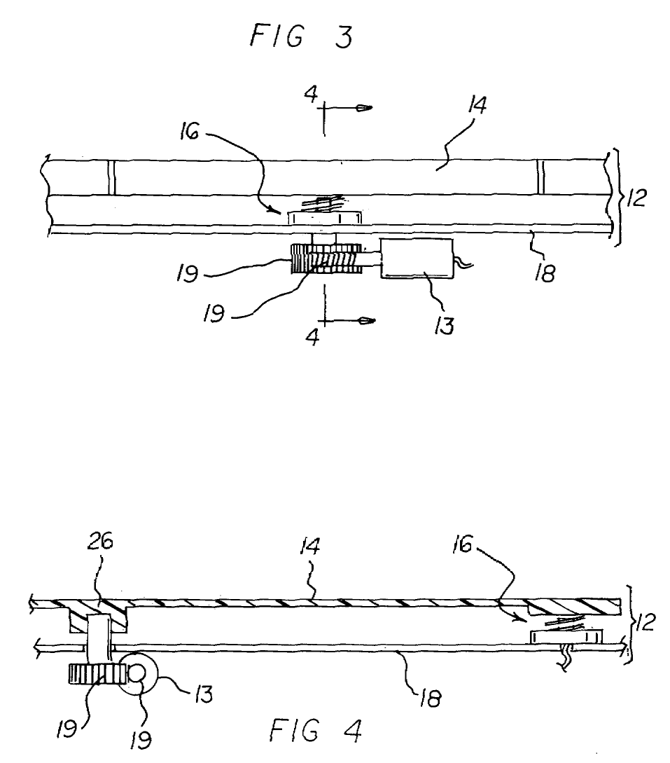

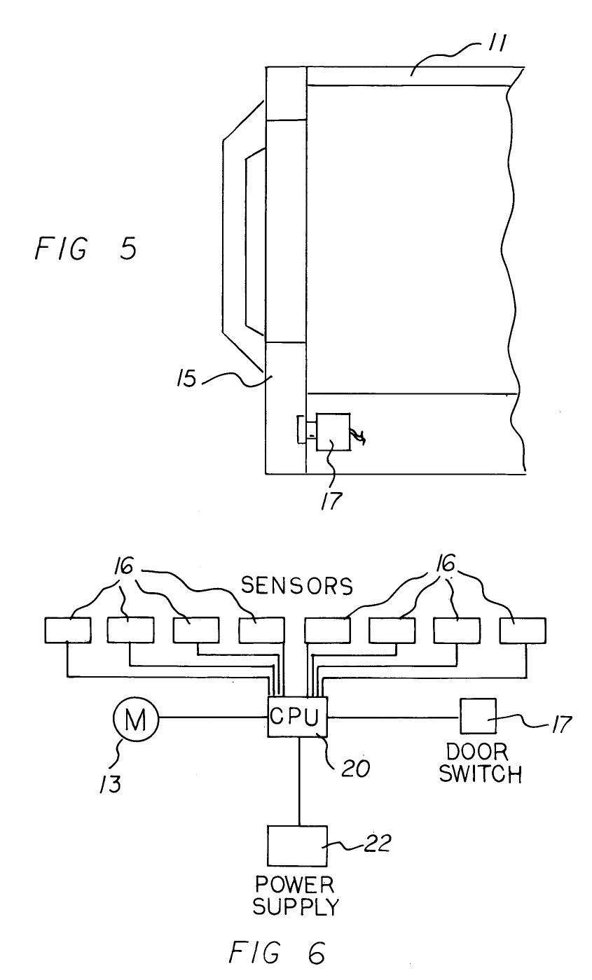

Turning to FIGS. 1-6, there is shown a preferred embodiment of the weight sensing microwave oven turntable apparatus of the invention generally designated by reference numeral 10. In each of the figures, reference numerals are shown that correspond to like reference numerals that designate like elements shown in other figures.

In the preferred embodiment, weight sensing microwave oven turntable apparatus 10 is provided for use in a microwave oven 11 which includes a turntable driving motor 13, turntable drive gearing 19 connected to the turntable driving motor 13, an oven door 15, and a door switch 17. The subject apparatus 10 is comprised of a turntable unit 12 which is mechanically connected to the turntable drive gearing 19. The turntable unit 12 includes a top turntable platform portion 14, a plurality of suitable weight sensors 16 located under the top turntable platform portion 14 and which support the top turntable platform portion 14, and a turntable base 18 which supports the plurality of weight sensors 16. Turntable control means are electrically connected to the turntable driving motor 13, are electrically connected to the plurality of weight sensors 16, and are electrically connected to the door switch 17. The turntable control means control the position of the turntable unit 12 with respect to the oven door 15 when the oven door 15 is open, by receiving signals from the weight sensors 16 and from the door switch 17, and by sending signals to the turntable driving motor 13.

Preferably, the plurality of weight sensors 16 are arrayed around the turntable unit 12 in a circular pattern. In addition, each of the plurality of weight sensors 16 is associated with a pie-shaped sector 24 of the turntable unit 12. More preferably, eight weight sensors 16 are associated with eight pie-shaped sectors 24 that are arrayed radially and circumferentially around a turntable center 26. When the turntable unit 12 rotates, it rotates around the turntable center 26.

Preferably, the turntable control means include a programmable microprocessor 20, and a power supply 22 is electrically connected to the microprocessor 20. The plurality of weight sensors 16 and the door switch 17 provide input signals to the microprocessor 20, and the turntable driving motor 13 is controlled by output signals from the microprocessor 20. Well known programmable microprocessors can be employed to implement the subject microprocessor 20. Well known weight sensors can also be employed, such as those disclosed in the above-mentioned U. S. Patent No. 5,463,207, incorporated herein by reference.

The microprocessor 20 is programmed to sense where on the microwave turntable an article such as a coffee or beverage container is located. More specifically, the microprocessor 20 is programmed to sense which weight sensor 16 is sensing the greatest amount of weight on the top turntable platform portion 14, to sense when the oven door 15 is open as signalled by the door switch 17, to activate the turntable driving motor 13 to drive the turntable drive gearing 19 to rotate the turntable unit 12 such that the weight sensor 16 which is sensing the greatest amount of weight on the top turntable platform portion 14 is moved to the oven door 15. More specifically, the pattern of weight distribution on the top turntable platform portion 14 that is sensed by the weight sensors 16 is detected by the microprocessor 20. In that pattern of weight distribution, there is generally one weight sensor 16 which senses the greatest portion of the weight exerted on the top turntable platform portion 14. In response to the one weight sensor 16 which senses the greatest portion of the weight exerted on the top turntable platform portion 14, the microprocessor 20 causes the turntable driving motor 13 to turn the turntable unit 12 to place that one weight sensor 16 and its associated top turntable platform portion proximal or next to the oven door 15 when the door is open (and the door-switch suitably activated).

Stated somewhat differently, the article, such as a food or beverage container containing heated food, resting on the top turntable platform portion 14, that is exerting the weight on the weight sensor 16 that is sensing the greatest amount of weight on the top turntable platform portion 14, is moved by rotation of the turntable unit 12 so that the food or beverage container is positioned proximal or next to the oven door 15. Then, when the user reaches in through the open oven door 15, the food or beverage container is easy to see, to grasp, and to remove from the microwave oven 11.

The components of the weight sensing microwave oven turntable apparatus of the invention can be made from inexpensive and durable metal and plastic materials, as well as weight sensors and microprocessors.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved article sensing microwave oven turntable apparatus that is low in cost, relatively simple in design and operation, and which may advantageously be used to be completely retained inside the microwave oven. With the invention, an article sensing microwave oven turntable apparatus is provided which has a plurality of sensors that are used to control rotation of the turntable so that the food in the microwave oven is positioned at the front of the microwave oven where the oven door is opened. With the invention, an article sensing microwave oven turntable apparatus is provided which includes a microprocessor for controlling the turntable rotation motor to suitably position the turntable proximal to or at the microwave door. With the invention, an article sensing microwave oven turntable apparatus is provided in which the turntable is divided into a plurality of sectors, and in which each sector has an associated weight sensor. With the invention, a weight sensing microwave oven turntable apparatus is provided in which control of a turntable motor is dependent upon the status of a microwave door switch and the status of weight distribution among a plurality of weight sensors.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use. For example, in lieu of weight sensors in the microwave turntable, other sensors such as photocells, may used to sense the presence of an article on a pie-shaped sector or plurality of sectors of the turntable through suitable optical transmission means provided in the turntable pie-shaped sectors as will occur to those of ordinary skill in the art.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A turntable apparatus for use in a microwave oven which includes a turntable driving motor, turntable drive mechanism connected to the turntable driving motor, an oven door, and a door switch, said apparatus comprising:
a turntable unit connected to the turntable drive mechanism, wherein said turntable unit includes a top turntable platform portion, a plurality of sensors located under said top turntable platform portion, and
turntable control means electrically connected to the turntable driving motor, electrically connected to said plurality of sensors, and electrically connected to the door switch, wherein said turntable control means controls the position of said turntable unit with respect to the oven door when the oven door is open, by receiving signals from said sensors and from the door switch, and by sending signals to the turntable driving motor.

2. The apparatus of claim 1 wherein said plurality of sensors are arrayed around said turntable unit in a circular pattern.

3. The apparatus of claim 2 wherein each of said plurality of sensors is associated respectively with an individual pie-shaped sector of said turntable unit.

4. The apparatus of claim 3 wherein eight sensors are associated with eight pie-shaped sectors arrayed radially around a turntable center.

5. The apparatus of claim 1 wherein said turntable control means include:
a programmable microprocessor, and
a power supply electrically connected to said microprocessor,
wherein said plurality of sensors and said door switch provide input signals to said microprocessor, and wherein the turntable driving motor is controlled by output signals from said microprocessor.

6. The apparatus of claim 5 wherein said microprocessor is programmed:
to sense which sensor is sensing the presence of an article on the top turntable platform portion,
to sense when the oven door is open as signalled by the door switch, and
to activate the turntable driving motor to drive the turntable drive mechanism to rotate said turntable unit such that said sensor which is sensing the article on the top turntable platform portion and its associated top turntable platform portion is moved to the oven door.

7. The apparatus of claim 6 wherein said sensor is a weight sensor adapted to sense the weight of said article on said top turntable platform portion associated therewith.

8. A method of controlling the position of a turntable unit with respect to a microwave oven door, wherein the turntable unit is driven by a turntable driving motor, said method comprising the steps of:
providing a plurality of sensors in the turntable unit,
providing a door switch for the oven door, and
providing a programmable microprocessor for sensing which sensor is sensing an article on the turntable unit, for sensing when the oven door is open as signalled by the door switch, and for activating the turntable driving motor to drive the turntable unit such that said sensor which is sensing the article on the top turntable platform portion and that top turntable platform portion are moved to be proximal to the oven door.
